(19) United States
(12) Patent Application Publication
(10) Pub. No.: US 2003/0127779 A1
(43) Pub. Date: Jul. 10, 2003

(54) Method for manufacturing shell and core composite structure

(76) Inventors: Yu-Hwey Chuang, Taichung (TW); Ming-Fa Sheu, Taichung (TW); Yung-Kun Lin, Taichung (TW); Ming-Jen Ting, Taichung (TW); Chin-Kun Lee, Taichung (TW); Han-Chi Liu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/050,127

(22) Filed: Jan. 18, 2002

(51) Int. Cl. B29C 45/14

(52) U.S. Cl. 264/510

(57) ABSTRACT

A method for forming a composite article including a core with fiber and resin outer layer includes step 1 of making first grooves in an outer surface of a core; step 2 of mounting a netted member to the core, if necessary; step 3 of laying up a composite material outer layer onto the netted member; step 4 of putting the core with the outer layer in a mold which has an inlet and an outlet both communicating with the composite material outer layer; step 5 of injecting resin into the inlet and sucking air from the outlet.

### FIELD OF THE INVENTION

The present invention relates to a method to form shell and core composite article with resin transfer molding process. The method requires lower pressure to inject the resin in the mold.

### BACKGROUND OF THE INVENTION

A conventional way to make a composite article is vacuum assisted resin transfer molding (VA-RTM). Referring to FIG. 9, the article includes a core 50 coated with composite material outer layer 60. The assembly comprising the core 50 and the composite material outer layer 60 is put in a set of mold 70. A compressor is used to inject resin into the mold 70 and a vacuum pump sucks the air to accelerate the flow rate of the resin to cover the article. It requires a huge compressor and a huge vacuum pump to move the resin and the resin is stocked at the inlet and the outlet of the mold 70. The compressor and vacuum pump are so expensive, however, can only obtain a slow flow rate. The air could be trapped in the mold and results in voids on the outer surface of the article. FIG. 10 shows a netted member 90 is mounted to the composite material outer layer 80 in which a core 95 is embraced. The netted member 90 guides the resin to quickly cover the composite material outer layer 80. The netted member 90 leaves serrated surface on the article and the flow rate of resin is not accelerated satisfactorily.

The present invention intends to provide a method that makes grooves in the outer surface of the core and if necessary, a netted member may be mounted to the core to form alternative grooves. A composite material outer layer is coated onto the netted member so that the composite material outer layer is easily soaked by the resin which is then guided into the grooves.

### SUMMARY OF THE INVENTION

In accordance with one aspect of the present invention, there is provided a method for forming a article including a core with fiber reinforced composite outer layer. The method comprises the following steps:

step 1: preparing a core and a plurality of first grooves defined in an outer surface thereof;

step 2: mounting a netted member to the core, if necessary;

step 3: laying up fiber onto core or netted member if it is used

step 4: putting the assembly in step 3 in a mold which has an inlet and an outlet both connecting to the composite material outer layer, and

step 5: injecting resin into the inlet and sucking air from the outlet.

The primary object of the present invention is to provide a method for manufacturing a core with polymer composite outer layer, wherein the core has alternative grooves to quickly guide the resin to soak the composite material layer and reach the core.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show grooves defined in the core;

FIG. 2 shows the netted member to be mounted to the core;

FIG. 3 is a perspective view to show the netted member is mounted to the core;

FIG. 4 is a cross sectional view to show the core coated with the netted member and the composite material layer is put in a mold;

FIG. 5 is a cross sectional view to show another core having a passage covered with the netted member and the composite material layer;

FIG. 6 shows that the mold is tilted when injecting resin in the mold;

FIG. 7 is a cross sectional view to show a curve mold is used in the method of the present invention;

FIG. 8 shows a cross section diagram of the curve mold in FIG. 7;

FIG. 9 is a cross sectional view to show a first conventional method to make the article, and

FIG. 10 is a cross sectional view to show a second conventional method to make the article.

### DETAILED DESCRIPTION OF THE PREFERRED EMBODIMENTS

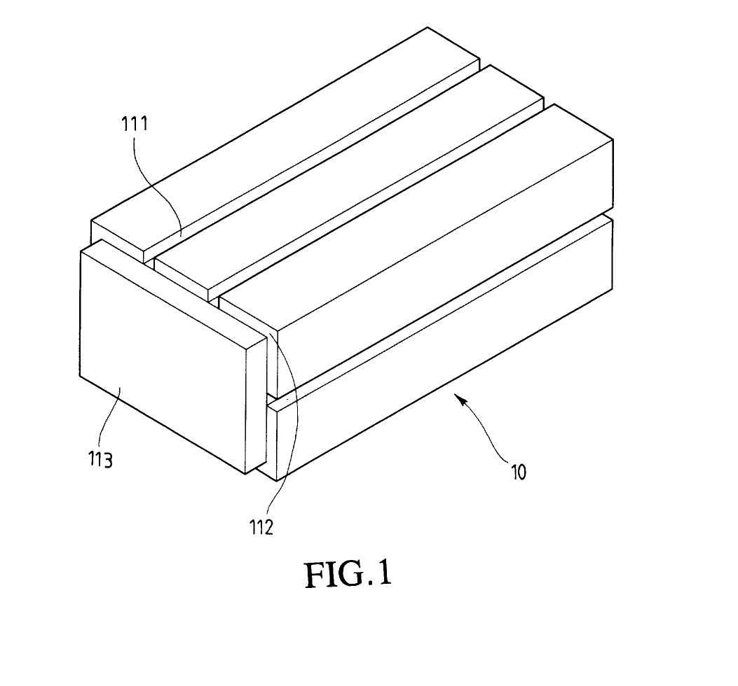

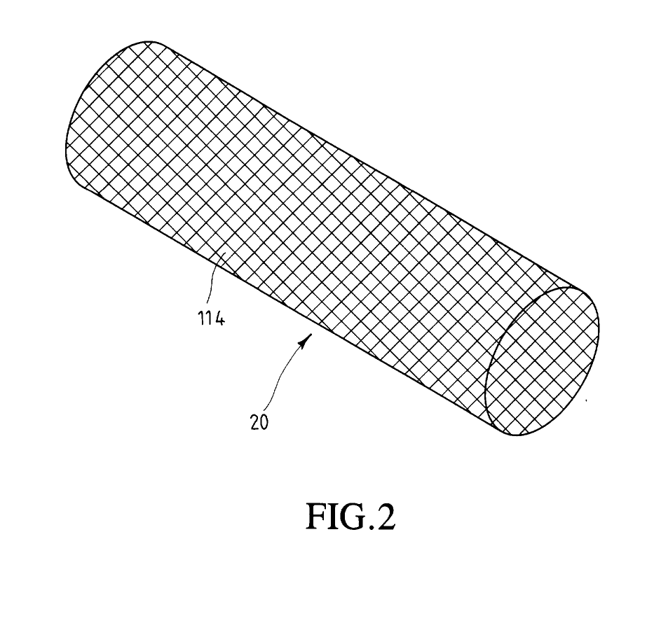

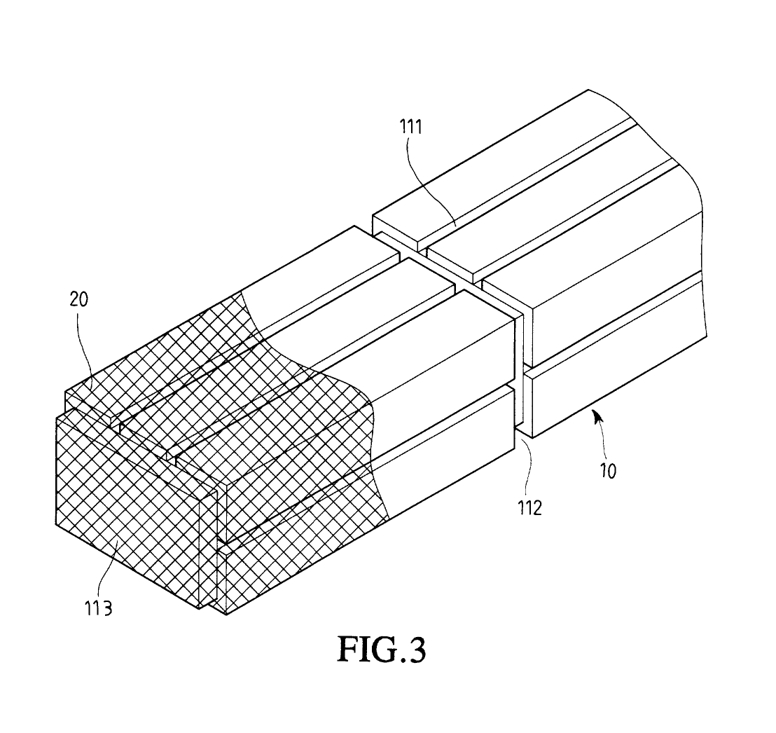

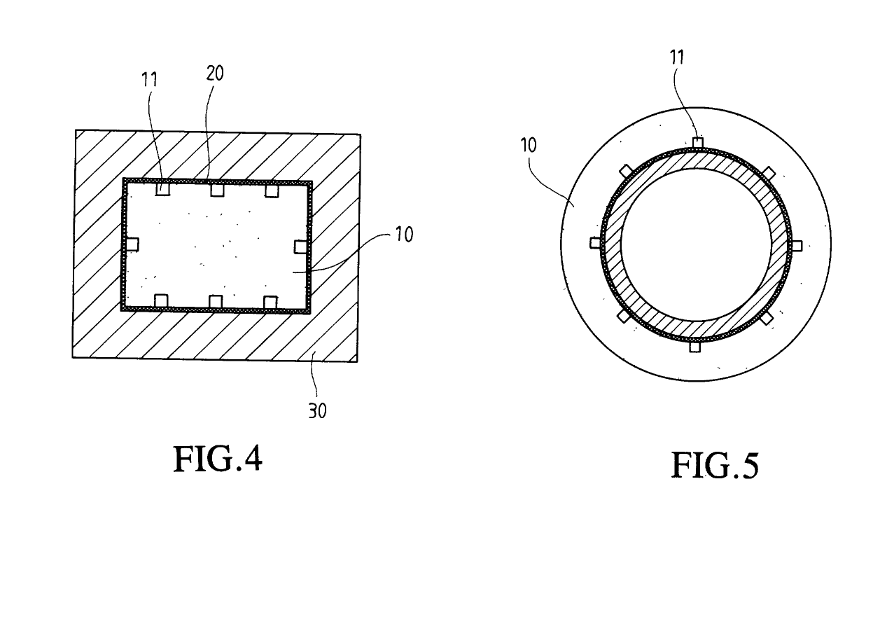

Referring to FIGS. 1 to 4, the method of the present invention comprises a the following steps:

step 1: preparing a core 10 and a plurality of first grooves 111 defined in an outer surface thereof.

The core 10 can be made of foam material, thermoplastics, thermo-setting plastics, or metal. The shape of the core 10 may be made according to the practical needs. The first grooves 111 are defined in a longitudinal direction of the core 10 and communicates with two ends of the core 10. An end head 113 extends from one of two ends of the core 10 and a second groove 112 is defined between the end head 113 and the core 10. The second groove 112 is substantially perpendicular to the first grooves 111 in the core 10. Other grooves that are perpendicular to the first grooves 111 may also be made when needed.

step 2: mounting a netted member 20 to the core 10. The netted member 20 can be metal or plastic netted member and has apertures 114.

step 3: laying up a composite material outer layer 30 onto the netted member 20 to form an assembly including the core 10, the netted member 20 and the composite material outer layer 30. The composite material layer 30 includes fibers and/or prepreg strips.

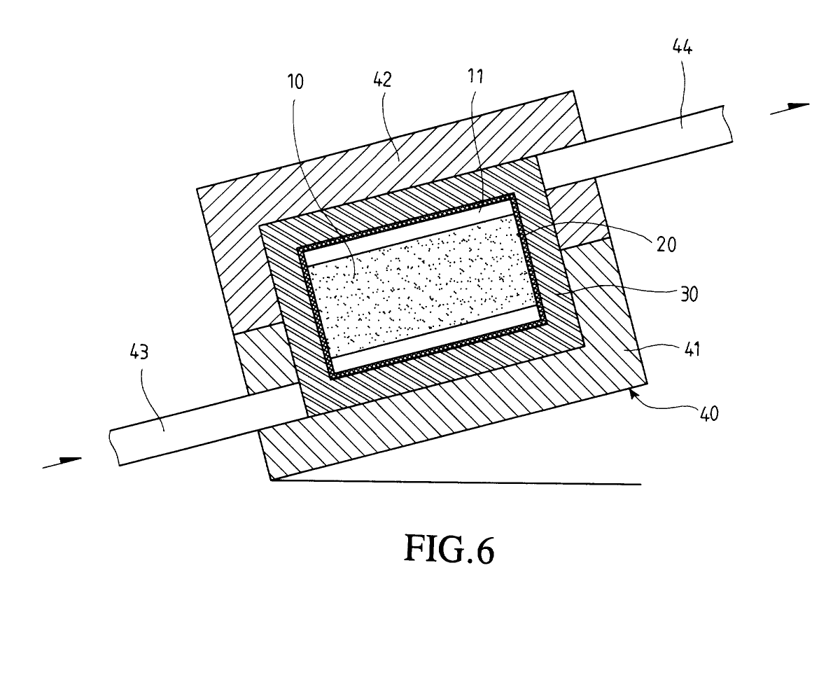

step 4: putting the assembly in step 3 in a mold 40 which has an inlet 43 and an outlet 44 both communicating with the composite material outer layer 30. The mold 40 as shown in FIG. 6 includes a first mold 41 and a second mold 42. The assembly is put in the cave between the first mole 41 and the second mold 42. The inlet 43 is defined in the first mold 41 and the outlet 44 is defined in the second mold 42.

step 5: injecting resin into the inlet 43 and sucking air from the outlet 44.

The mold 40 is tilted an angle to accelerate the flow rate of the resin in the mold 40.

The resin quickly soaks the composite material outer layer 30 and reaches the core 10 by the first grooves 111 and the second grooves 112 and the netted member 20. The flow rate of the resin can be increases and the compressor and the vacuum pump cooperated with the method do not need to be huge.

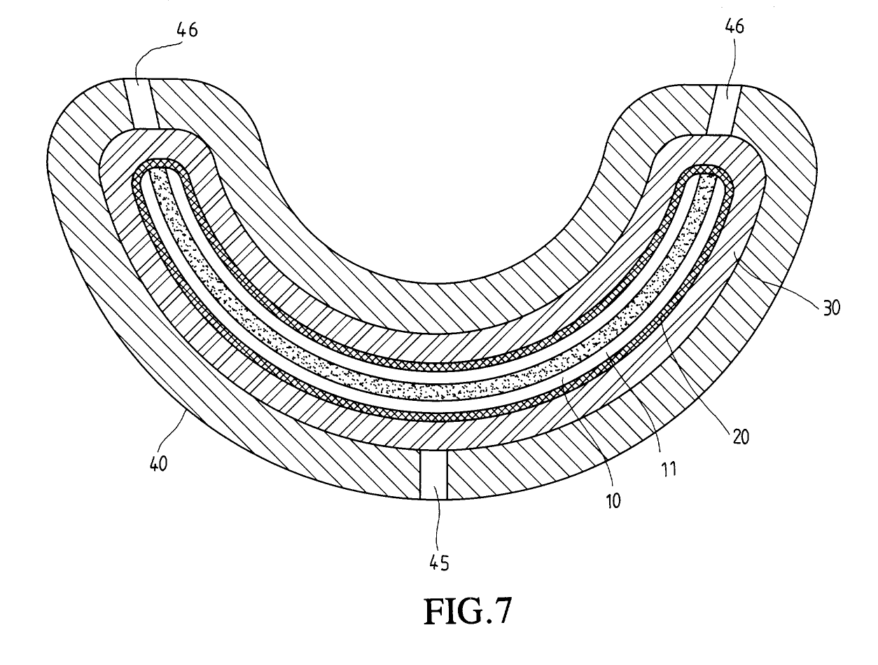

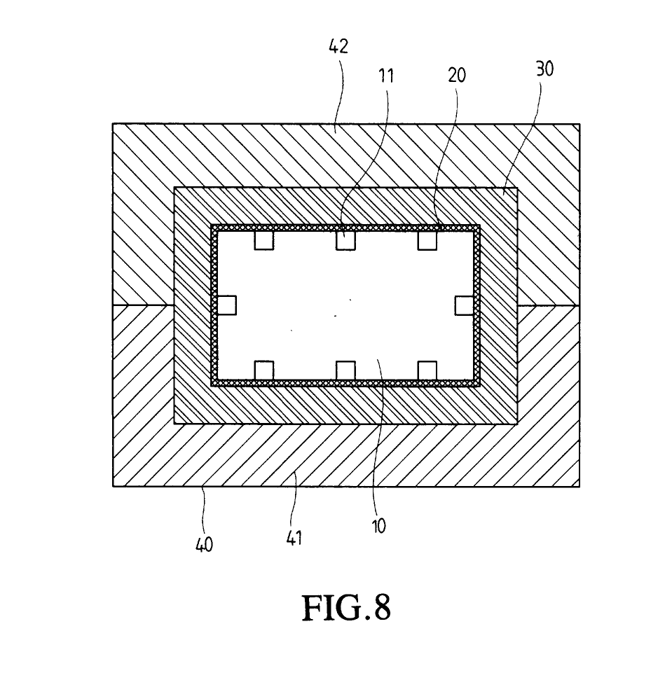

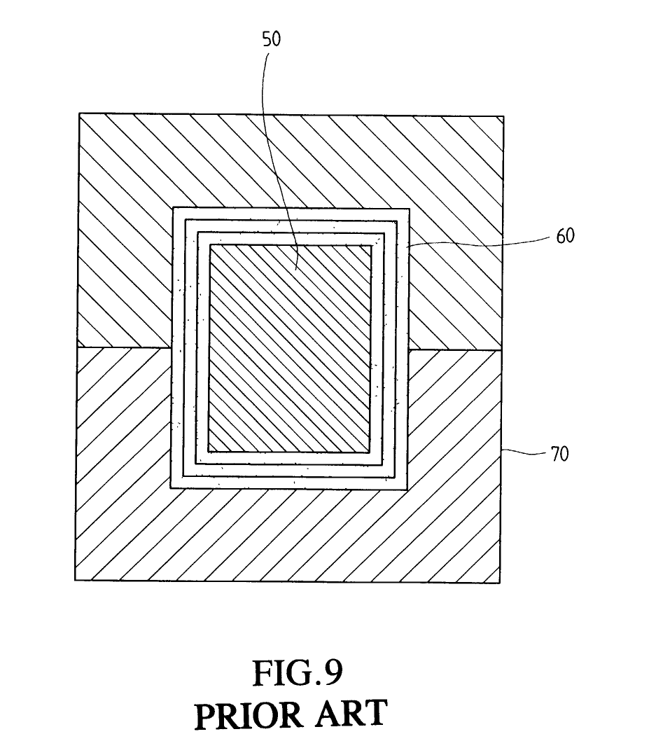

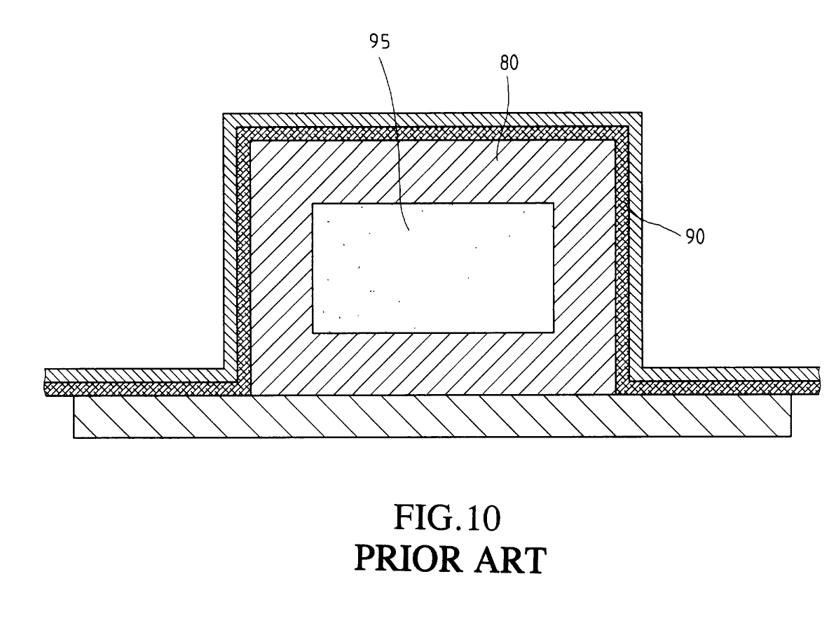

Referring to FIGS. 7 and 8, the shape of the mold 40 can be made to meet practical need such as a curve mold as shown. The inlet 45 is defined in a surface of the mold 40 and two outlets 46 are defined in two ends of the mold 40.

FIG. 5 shows that the core has a passage defined therethrough and the method of the present invention to coat a composite fiber and resin layer comprises the following steps:

step 1: preparing a core 10 which has a passage defined therethrough, a plurality of first grooves 111 defined in an inner surface of the passage;

step 2: adhering a netted member 20 to the inner surface of the passage of the core 10;

step 3: laying up a composite material layer 30 onto the netted member 20 to form an assembly including the core, the netted member and the composite material layer; and

step 4: injecting resin into the passage from one end of the core 10 and sucking air from the other end of the core 10.

The article made by the method of the present invention left no marks of the netted member on the outer surface thereof and the pressure required to inject the resin into the mold is reduced so that the expenses for the mold and the compressor and the vacuum pump can be reduced. The resin is quickly engaged with the composite material and the core so that the structural quality is increased.

The present invention can also be used in any combination of two material types e.g. metal/polymer composites, plastic/polymer composites, pre-cured polymer composites/polymer composites, etc. The resin transfer molding (RTM ) process can be used to form the polymer composites etheir on the core 50 or the outer layer 60. Groves are always made at the surface other than composites member to be made by RTM. Netted member is only to be used when grooving is difficult or when very thick composite parts are expected.

While we have shown and described the embodiment in accordance with the present invention, it should be clear to those skilled in the art that further embodiments may be made without departing from the scope of the present invention.

What is claimed is:

1. A method for forming a shell and core composite article including one polymer composite and one othe material , comprising the following steps:
step 1: preparing grooves at etheir surface located at the interface of these two materials thereof;
step 2: mounting a netted member to the core, if necessary;
step 3: laying up a composite material outer layer onto the netted member to form an assembly including the core, the netted member and the composite material outer layer;
step 4: putting the assembly in step 2 in a mold which has an inlet and an outlet both communicating with the composite material outer layer, and
step 5: injecting resin into the inlet and sucking air from the outlet.

2. The method as claimed in claim 1 wherein the othe material is chosen from metal, foam, plastic, ceramics or procured polymer composites.

3. The method as claimed in claim 1 wherein the grooves are made at the surface other than the polymer composite member to be made by resin transfer molding process.

4. The method as claimed in claim 1 further comprising an end head extending from one of two ends of the core and a second groove defined between the end head and the core.

5. The method as claimed in claim 4 wherein the second groove is substantially perpendicular to the first grooves in the core.

6. The method as claimed in claim 1 wherein the mold is tilted in step 5.

7. The method as claimed in claim 1 further comprising a step of mounting a netted member to the core between said step 1 and said step 2.

8. A method for forming a composite article including a core with fiber and resin layer, comprising the following steps:
step 1: preparing a core which has a passage defined therethrough, a plurality of first grooves defined in an inner surface of the passage;
step 2: mounting a netted member to the inner surface of the passage of the core;
step 3: coating a composite material layer onto the netted member to form an assembly including the core, the netted member and the composite material layer; and
step 4: injecting resin into the passage from one end of the core and sucking air from the other end of the core.
